(19) United States
(12) Patent Application Publication
(10) Pub. No.: US 2003/0130977 A1
(43) Pub. Date: Jul. 10, 2003

(54) Method for recognizing trees by processing potentially noisy subsequence trees

(76) Inventor: B. John Oommen, (US)

Correspondence Address: David J. French, Stn. "D", P.O. Box 2486, Ottawa, K1P 5W6, CA

(21) Appl. No.: 10/368,387

(22) Filed: Feb. 20, 2003

Related U.S. Application Data
(63) Continuation-in-part of application No. 09/369,349, filed on Aug. 6, 1999.

(51) Int. Cl. G06N 7/00; G06N 7/08; G06F 17/00

(52) U.S. Cl. 706/59

(57) ABSTRACT

A process for identifying the original tree, which is a member of a dictionary of labelled ordered trees, by processing a potentially Noisy Subsequence-Tree. The original tree relates to the Noisy Subsequence-Tree through a Subsequence-Tree, which is an arbitrary subsequence-tree of the original tree, which is further subjected to substitution, insertion and deletion errors yielding the Noisy Subsequence-Tree. This invention has application to the general area of comparing tree structures which is commonly used in computer science, and in particular to the areas of statistical, syntactic and structural pattern recognition.

This application is a continuation-in-part of U.S. Ser. No. 09/369,349 filed August 6, 1999.

### FIELD OF THE INVENTION

This invention pertains to the field of tree-editing commonly used in statistical, syntactic and structural pattern recognition processes.

### BACKGROUND OF THE INVENTION

Trees are a fundamental data structure in computer science. A tree is, in general, a structure which stores data and it consists of atomic components called nodes and branches. The node have values which relate to data from the real world, and the branches connect the nodes so as to denote the relationship between the pieces of data resident in the nodes. By definition, no edges of a tree constitute a closed path or cycle. Every tree has a unique node called a “root”. The branch from a node toward the root points to the “parent” of the said node. Similarly, the branch of the node away from the root points to the “child” of the said node. The tree is said to be ordered if there is a left-to-right ordering for the children of every node.

Trees have numerous applications in various fields of computer science including artificial intelligence, data modelling, pattern recognition, and expert systems. In all of these fields, the trees structures are processed by using operations such as deleting their nodes, inserting nodes, substituting node values, pruning sub-trees, from the trees, and traversing the nodes in the trees. When more than one tree is involved, operations that are generally utilized involve the merging of trees and the splitting of trees into multiple subtrees. In many of the applications which deal with multiple trees, the fundamental problem involves that of comparing them.

This invention provides a novel means by which tree structures can be compared. The invention can be used for identifying an original tree, which is a member of a dictionary of labeled ordered trees. The invention achieves this recognition by processing a Noisy Subsequence-Tree (NSuT), which is a noisy or garbled version of any one arbitrary Subsequence-Tree (SuT) of the original tree. Indeed, a NSuT is an subsequence-tree, which is further subjected to substitution, insertion and deletion errors.

The invention can be applied to any field which compares tree structures, and in particular to the areas of statistical, syntactic and structural pattern recognition.

Unlike the string-editing problem, only few results have been published concerning the tree-editing problem. In 1977 Selkow [Se77, SK83] presented a tree editing algorithm in which insertions and deletions were only restricted to the leaves. Tai [Ta79] in 1979 presented another algorithm in which insertions and deletions could take place at any node within the tree except the root. The algorithm of Lu [Lu79], on the other hand, did not solve this problem for trees of more than two levels. The best known algorithm for solving the general tree-editing problem is the one due to Zhang and Shasha [ZS89]. Also, to the best of our knowledge, in all the papers published till the mid-90's, the literature primarily contains only one numeric inter-tree dissimilarity measure—their pairwise “distance” measured by the minimum cost edit sequence.

The literature on the comparison of trees is otherwise scanty: Zhang [SZ90] has suggested how tree comparison can be done for ordered and unordered labeled trees using tree alignment as opposed to the edit distance utilized elsewhere [ZS89]. The question of comparing trees with “Variable Length Don't Care” edit operations was also recently solved by Zhang et. al. [ZSW92]. Otherwise, the results concerning unordered trees are primarily complexity results [ZSS92]—editing unordered trees with bounded degrees is shown to be NP-hard in [ZSS92] and even MAX SNP-hard in [ZJ94].

The most recent results concerning tree comparisons are probably the ones due to Oommen, Zhang and Lee [OZL96]. In [OZL96] the authors defined and formulated an abstract measure of comparison, Ω(T₁, T₂), between two trees T₁ and T₂ presented in terms of a set of elementary inter-symbol measures ω(.,.) and two abstract operators. By appropriately choosing the concrete values for these two operators and for ω(.,.), the measure Ω was used to define various numeric quantities between T₁ and T₂ including (i) the edit distance between two trees, (ii) the size of their largest common sub-tree, (iii) Prob(T₂|T₁), the probability of receiving T₂ given that T₁ was transmitted across a channel causing independent substitution and deletion errors, and, (iv) the a posteriori probability of T₁ being the transmitted tree given that T₂ is the received tree containing independent substitution, insertion and deletion errors.

Unlike the generalized tree editing problem, the problem of comparing a tree with one of its possible subtrees or SuTs has almost not been studied in the literature at all.

### SUMMARY Or THE INVENTION

It is an object of this invention to provide a method implemented in data processing apparatus for comparing two trees using a constrained edit distance between the trees, wherein the said constraint is related to the probability of a node value, from the set of possible node values, being substituted.

It is an object of this invention to provide a method implemented in data processing apparatus for comparing two trees using a constrained edit distance between the trees, wherein the said constraint is related to the probability of a node value from the first tree being not deleted.

It is a further object of this invention to provide a method implemented in data processing apparatus for comparing two trees using a constrained edit distance between the trees, wherein the said constraint is related to the probability of a node value from the second tree being not inserted.

It is still a further object of this invention to provide a method implemented in data processing apparatus for recognizing trees wherein the tree is recognized by computing the constrained edit distance between the set of potential trees and the sample tree which is to be recognized.

### BRIEF DESCRIPTION OF THE FIGURES

FIG. 1 presents an example of a tree X*, U, one of its Subsequence Trees, and Y which is a noisy version of U. The problem involves recognizing X* from Y.

FIG. 2 presents an example of the insertion of a node.

FIG. 3 presents an example of the deletion of a node.

FIG. 4 presents an example of the substitution of a node by another.

FIG. 5 presents an example of a mapping between two labeled ordered trees.

FIG. 6 demonstrates a tree from the finite dictionary H. Its associated list representation is as follows: ((((t)z)(((j)s)(t)(u)(v)x)a)((f)(((u)(v)a)(b)((p)c)(((i)(((q)(r)g)j)k)s)((x)(y)(z)e)d)

### DESCRIPTION OF THE INVENTION

The method of this invention provides a novel means for identifying the original tree, which is a member of a dictionary of labeled ordered trees, by processing a Noisy Subsequence-Tree (NSuT). The original tree relates to the NSuT through a Subsequence-Tree (SuT). An SuT is an arbitrary subsequence-tree of the original tree, which is further subjected to substitution, insertion and deletion errors yielding the NSuT.

This method is rendered possible by taking into consideration the information about the noise characteristics of the channel which garbles U. Indeed, these characteristics are translated into edit constraints whence a constrained tree editing algorithm can be invoked to perform the classification.

This method is not a mere extension of the string editing problem. This is because, unlike in the case of strings, the topological structure of the underlying graph prohibits the two-dimensional generalizations of the corresponding computations. Indeed, inter-tree computations require the simultaneous maintenance of meta-tree considerations represented as the parent and sibling properties of the respective trees, which are completely ignored in the case of linear structures such as strings. This further justifies the intuition that not all “string properties” generalize naturally to their corresponding “tree properties”, as will be clarified later.

The problem solved by the invention can be explicitly described as follows. We consider the problem of recognizing ordered labeled trees by processing their noisy subsequence-trees which are “patched-up” noisy portions of their fragments. We assume that we are given H, a finite dictionary of ordered labeled trees. X* is an unknown element of H, and U is any arbitrary subsequence-tree of X*. We consider the problem of estimating X* by processing Y, which is a noisy version of U. The solution which we present is pioneering.

We solve the problem by sequentially comparing Y with every element X of H, the basis of comparison being the constrained edit distance between two trees described presently. Although the actual constraint used in evaluating the constrained distance can be any arbitrary edit constraint involving the number and type of edit operations to be performed, in this scenario we use a specific constraint which implicitly captures the properties of the corrupting mechanism (“channel”) which noisily garbles U into Y.

Since Y is a noisy version of a subsequence tree of X*, (and not a noisy version of X* itself), clearly, just as in the case of recognizing noisy subsequences from strings [Oo87], it is meaningless to compare Y with all the trees in the dictionary themselves even though they were the potential sources of Y. The fundamental drawback in such a comparison strategy is the fact that significant information was deleted from X* even before Y was generated, and so Y should rather be compared with every possible subsequence tree of every tree in the dictionary. Clearly, this is intractable, since the number of SuTs of a tree is exponentially large and so a need exists for an alternative method for comparing Y with every X in H is needed.

The method of the invention is performed using the concepts of constrained edit distances that are described below. The model used for the recognition process is quite straightforward. First of all we assume that a “Transmitter” intends to transmit a tree X* which is an element of a finite dictionary of trees, H. However, rather than transmitting the original tree he opts to randomly delete nodes from X* and transmit one of its subsequence trees, U. The transmission of U is across a noisy channel which is capable of introducing substitution, deletion and insertion errors at the nodes. Note that, to render the problem meaningful (and distinct from the uni-dimensional one studied in the literature) we assume that the tree itself is transmitted as a two dimensional entity. In other words we do not consider the serialization of this transmission process, for that would merely involve transmitting a string representation, which would, typically, be a traversal pre-defined by both the Transmitter and the Receiver. The receiver receives Y, a noisy version of U. Using this model we now present the method by which we recognize X* from Y.

To render the problem tractable, we assume that some of the properties of the channel can be observed. More specifically, we assume that L, the expected number of substitutions introduced in the process of transmitting U, can be estimated. In the simplest scenario (where the transmitted nodes are either deleted or substituted for) this quantity is obtained as the expected value for a mixture of Bernoulli trials, where each trial records the success of a node value being transmitted as an non-null symbol. Since the probability of having a node value transmitted is usually high and close to unity, L is usually close to the size of the NSuT, Y.

Since U can be an arbitrary subsequence tree of X*, it is obviously meaningless to compare Y with every X ∈ H using any known unconstrained tree editing algorithm. Clearly, before we compare Y to the individual tree in H, we have to use the additional information obtainable from the noisy channel. Also, since the specific number of substitutions (or insertions/deletions) introduced in any specific transmission is unknown, it is reasonable to compare any X ∈ H and Y subject to the constraint that the number of substitutions that actually took place is its best estimate. Of course, in the absence of any other information, the best estimate of the number of substitutions that could have taken place is indeed its expected value, L, which is usually close to the size of the NSuT, Y. One could therefore use the set {L} as the constraint set to effectively compare Y with any X ∈ H. Since the latter set can be quite restrictive, we opt to use a constraint set which is a superset of {L} marginally larger than {L}. Indeed, one such superset used for the experiments reported in this document contains merely the neighbouring values, and is {L−1, L, L+1}. Since the size of the set is still a constant, there is no significant increase in the computation times.

The element of H that minimizes this constrained tree distance is reported as the estimate of X*.

Concepts of Constrained Edit Distances

Let N be an alphabet and N* be the set of trees whose nodes are elements of N. Let μ be the null tree, which is distinct from λ, the null label not in N. Ñ=N ∪{λ}. A tree T ∈ N* with M nodes is said to be of size |T|=M, and will be represented in terms of the postorder numbering of its nodes. The advantages of this ordering are catalogued in [ZS89]. Let T[i] be the i^{th} node in the tree according to the left-to-right postorder numbering, and let δ(i) represent the postorder number of the leftmost leaf descendant of the subtree rooted at T[i]. Note that when T[i] is a leaf, δ(i)=i. T[i . . . j] represents the postorder forest induced by nodes T[i] to T[j] inclusive, of tree T. T[δ(i) . . . i] will be referred to as Tree(i). Size(i) is the number of nodes in Tree(i). The father of i is denoted as f(i). If f⁰(i)=i, the node f^{k}(i) can be recursively defined as f^{k}(i)=f(f^{k-1}(i)). The set of ancestors of i is: Anc(i)={f^{k}(i)|0≦k≦Depth(i)}.

An edit operation on a tree is either an insertion, a deletion or a substitution of one node by another. In terms of notation, an edit operation is represented symbolically as: x→y where x and y can either be a node label or λ, the null label. x=λ and y≠λ represents an insertion; x≠λ and y=λ represents a deletion; and x≠λ and y≠λ represents a substitution. Note that the case of x=λ and y=λ has not been defined—it is not needed.

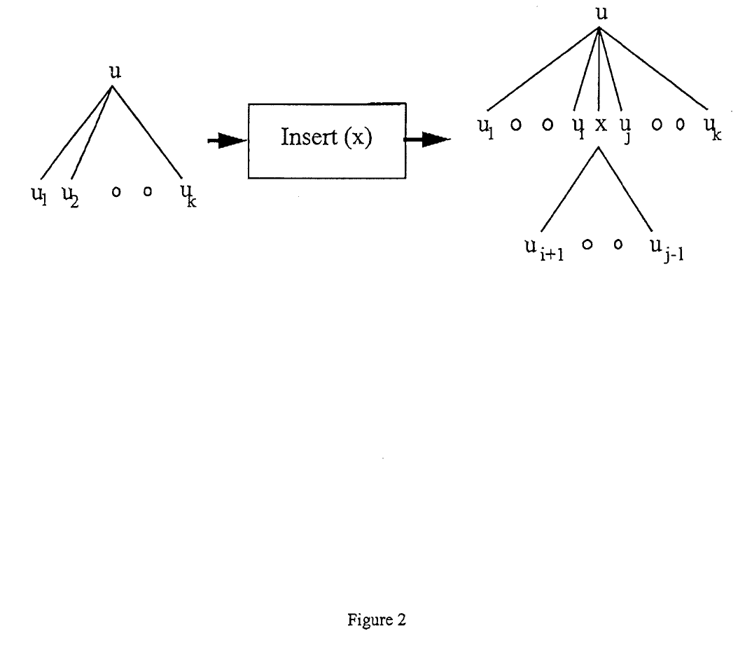

The operation of insertion of node x into tree T states that node x will be inserted as a son of some node u of T. It may either be inserted with no sons or take as sons any subsequence of the sons of u. If u has sons u₁, u₂, . . . , uₖ, then for some 0≦i≦j≦k, node u in the resulting tree will have sons u₁, . . . , uᵢ, x, uⱼ, . . . , uₖ, and node x will have no sons if j=i+1, or else have sons uᵢ₊₁, . . . , uⱼ₋₁. This edit operation is shown in FIG. 2.

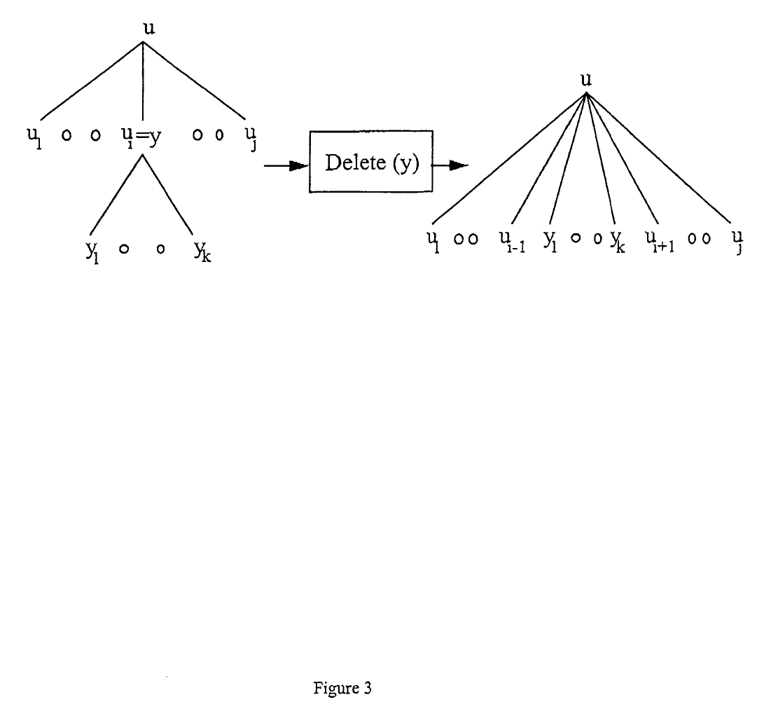

The operation of deletion of node y from a tree T states that if node y has sons y₁, y₂, . . . , yₖ and node u, the father of y, has sons u₁, u₂, . . . , uⱼ with uᵢ=y, then node u in the resulting tree obtained by the deletion will have sons u₁u₂, . . . , uᵢ₋₁, Y₁, Y₂, . . . , Yₖ, uᵢ₊₁, . . . , uⱼ. This edit operation is shown in FIG. 3.

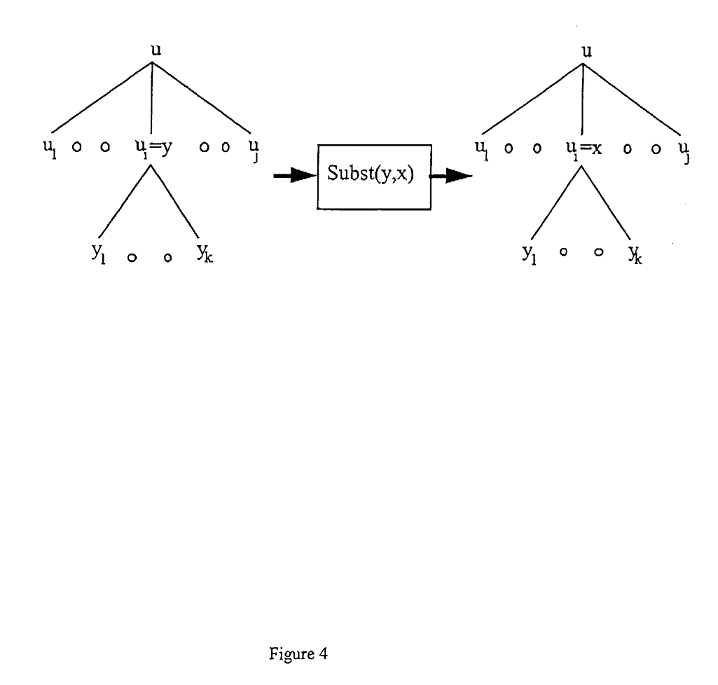

The operation of substituting node x by node y in T states that node y in the resulting tree will have the same father and sons as node x in the original tree. This edit operation is shown in FIG. 4.

Let d(x, y)>0 be the cost of transforming node x to node y. If x≠λ≠y, d(x, y) will represent the cost of substitution of node x by node y. Similarly, x≠λ, y=λ and x=λ, y≠λ will represent the cost of deletion and insertion of node x and y respectively. We assume that:

(1) d(x, y)>0; d(x, x)=0

(2) d(x, y)=d(y, x); and

(3) d(x, z)≦d(x, y)+d(y, z)

where (3) is essentially a “triangular” inequality constraint.

Although, in general, these distances are symbol dependent, in their simplest assignment the distances can be assigned the value of unity for the deletion, insertion and the non-equal substitution, and a value of zero for the substitution of a symbol by itself.

Let S be a sequence s₁, . . . , Sₖ of edit operations. An S-derivation from A to B is a sequence of trees A₀, . . . , Aₖ such that A=A₀, B=Aₖ, and Aᵢ₋₁→Aᵢ via sᵢ for 1≦i≦k. We extend the inter-node edit distance d(.,.) to the sequence S by assigning:

$$W ( S ) = {\sum }_{i = 1}^{\vert S \vert} d ( {s}_{i} ) .$$

With the introduction of W(S), the distance between T₁ and T₂ can be defined as follows:

D(T₁, T₂)=Min {W(S)|S is an S-derivation transforming T₁ to T₂}.

It is easy to observe that:

$$D ( {T}_{1} , {T}_{2} ) \leq d ( {T}_{1} [ \vert {T}_{1} \vert ] , {T}_{2} [ \vert {T}_{2} \vert ] ) + {\sum }_{i = 1}^{\vert {T}_{1} \vert - 1} d ( {T}_{1} [ i ] , λ ) + {\sum }_{j = 1}^{\vert {T}_{2} \vert - 1} d ( λ , {T}_{2} [ j ] ) .$$

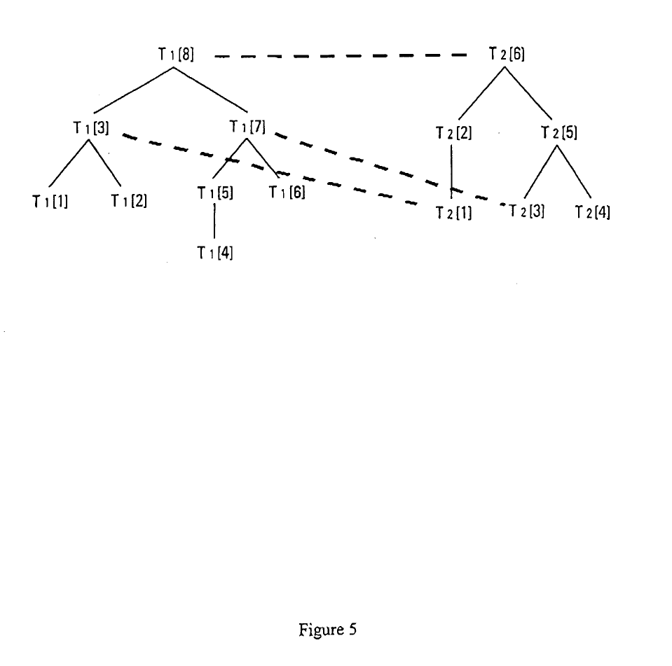

The operation of mapping between trees is a description of how a sequence of edit operations transforms T₁ into T₂. A pictorial representation of a mapping is given in FIG. 5. Informally, in a mapping the following holds:

(i) Lines connecting T₁[i] and T₂[j ] correspond to substituting T₁[i] by T₂[j].

(ii) Nodes in T₁ not touched by any line are to be deleted.

(iii) Nodes in T₂ not touched by any line are to be inserted.

Formally, a mapping is a triple (M, T₁, T₂), where M is any set of pairs of integers (i, j) satisfying:

(i) 1≦i≦|T₁|, 1≦j≦|T₂|;

(ii) For any pair of (i₁, j₁) and (i₂, j₂) in M,

(a) i₁=I₂ if and only if j₁=j₂ (one-to-one).

(b) T₁[i₁] is to the left of T₁[i₂] is to the left of T₂[j₂] (the Sibling Property).

(c) T₁[i₁] is an ancestor of T₁[i₂] if and only if T₂[j₁] is an ancestor of T₂[j₂] (the Ancestor Property)

Whenever there is no ambiguity we will use M to represent the triple (M, T₁, T₂), the mapping from T₁ to T₂. Let I, J be sets of nodes in T₁ and T₂, respectively, not touched by any lines in M. Then we can define the cost of M as follows:

$$cost ( M ) = {\sum }_{( i , j ) ∈ M} d ( {T}_{1} [ i ] , {T}_{2} [ j ] ) + {\sum }_{i ∈ I} d ( {T}_{1} [ i ] , λ ) + {\sum }_{j ∈ J} d ( λ , {T}_{2} [ j ] ) .$$

Since mappings can be composed to yield new mappings [Ta79, ZS89], the relationship between a mapping and a sequence of edit operations can now be specified.

Lemma I.

Given S, an S-derivation s₁, . . . , sₖ of edit operations from T₁ to T₂, there exists a mapping M from T₁ to T₂ such that cost (M)≦W(S). Conversely, for any mapping M, there exists a sequence of editing operations such that W(S)=cost (M).

Due to the above lemma, we obtain:

D(T₁, T₂)=Min {cost(M)|M is a mapping from T₁ to T₂}.

Thus, to search for the minimal cost edit sequence we need to only search for the optimal mapping.

Edit Constraints

Consider the problem of editing T₁ to T₂, where |T₁|=N and |T₂|=M. Editing a postorder-forest of T₁ into a postorder-forest of T₂ using exactly i insertions, e deletions, and s substitutions, corresponds to editing T₁[1 . . . e+s] into T₂[1. . . i+s]. To obtain bounds on the magnitudes of variables i, e, s, we observe that they are constrained by the sizes of trees T₁ and T₂. Thus, if r=e+s, q=i+s, and R=Min{N, M}, these variables will have to obey the following constraints:

max{0, M-N}≦i≦q≦M,

0≦e≦r≦N,

0≦s≦R.

Values of (i,e,s) which satisfy these constraints are termed feasible values of the variables. Let

Hᵢ={j|max{0, M-N}≦j≦M},

Hₑ={j|0≦j≦N}, and,

Hₛ={j|0≦j≦Min{M, N}}.

Hᵢ, Hₑ, and Hₛ are called the set of permissible values of i, e, and s.

Theorem I specifies the feasible triples for editing T₁[1 . . . r] to T₂[1 . . . q].

Theorem I.

To edit T₁[1 . . . r], the postorder-forest of T₁ of size r, to T₂[1 . . . q], the postorder-forest of T₂ of size q, the set of feasible triples is given by {(q-s, r-s, s)|0≦s≦Min{M, N}}.

The following result is true about any arbitrary constraint involving a pair of trees T₁ and T₂.

Theorem II.

Every edit constraint specified for the process of editing T₁ to T₂ is a unique subset of Hₛ.

The distance subject to the constraint τ as D_{τ}(T₁, T₂). By definition, D_{τ}(T₁, T₂)=∞ if τ is null.

We now consider the computation of D_{τ}(T₁, T₂).

Constrained Tree Editing

Since edit constraints can be written as unique subsets of Hₛ, we denote the distance between forest T₁[i′ . . . i] and forest T₂[j′ . . . j] subject to the constraint that exactly s substitutions are performed by Const_F_Wt(T₁[i′ . . . i], T₂[j′ . . . j], s) or more precisely by Const_F_Wt([i′ . . . i], [j′ . . . j], s). The distance between T₁[1 . . . i] and T₂[1 . . . j] subject to this constraint is given by Const_F_Wt(i, j, s) since the starting index of both trees is unity. As opposed to this, the distance between the subtree rooted at i and the subtree rooted at j subject to the same constraint is given by Const_T_Wt(i, j, s). The difference between Const_F_Wt and Const_T_Wt is subtle. Indeed,

Const_T_Wt(i, j, s)=Const_F_Wt(T₁[δ(i) . . . i], T₂[δ(j) . . . j], s).

These weights obey the following properties proved in [OL94].

Lemma II

Let i₁ ∈ Anc(i) and j₁ ∈ Anc(j). Then

(i) Const_F_Wt(μ, μ, 0)=0.

(ii) Const_F_Wt(T₁[δ(i₁) . . . i], μ, 0)=Const_F_Wt(T₁[δ(i₁) . . . i-1], μ, 0)+d(T₁[i], λ).

(iii) Const_F_Wt(μ, T₂[δ(j₁) . . . j], 0)=Const_F_Wt(μ, T₂[δ(j₁) . . . j-1], 0)+d(λ, T₂[j]).

$$( iv ) Const\_F \_Wt ( {T}_{1} [ δ ( {i}_{1} ) . . . i ] , {T}_{2} [ δ ( {j}_{1} ) . . . j ] , 0 ) = Min \{ \begin{matrix}Const\_F \_Wt ( {T}_{1} [ δ ( {i}_{1} ) . . . i - 1 ] , {T}_{2} [ δ ( {j}_{1} ) . . . j ] , 0 ) + d ( {T}_{1} [ i ] , λ ) \\ Const\_F \_Wt ( {T}_{1} [ δ ( {i}_{1} ) . . . i ] , {T}_{2} [ δ ( {j}_{1} ) . . . j - 1 ] , 0 ) + d ( λ , {T}_{2} [ j ] ) .\end{matrix}$$

(v)Const_F_Wt(T₁[δ(i₁) . . . i], μ, s)=∞ if s>0.

(vi) Const_F_Wt(μ, T₂[δ(j₁) . . . j], s)=∞ if s>0.

(vii) Const_Wt(μ, μ, s)=∞ if s>0.

Lemma II essentially states the properties of the constrained distance when either s is zero or when either of the trees is null. These are thus “basis” cases that can be used in any recursive computation. For the non-basis cases we consider the scenarios when the trees are non-empty and when the constraining parameter, s, is strictly positive. The recursive property of Const_F_Wt is given by Theorem III.

Theorem III.

$$\begin{matrix}Let {i}_{1} ∈ Anc ( i ) and {j}_{1} ∈ Anc ( j ) .\end{matrix} \\ Then C onst\_F \_Wt ( {T}_{1} [ δ ( {i}_{1} ) … i ] , {T}_{2} [ δ ( {j}_{1} ) … j ] , s ) = Min \{ \begin{matrix}Const\_F \_Wt ( [ δ ( {i}_{1} ) … i - 1 ] , [ δ ( {j}_{1} ) … j ] , s ) + d ( {T}_{1} [ i ] , λ ) \\ Const\_F \_Wt ( [ δ ( {i}_{1} ) … i ] , [ δ ( {j}_{1} ) … j - 1 ] , s ) + d ( λ , {T}_{2} [ j ] ) \\ \begin{matrix}Min \\ 1 \leq {s}_{2} \leq Min \{ Size ( i ) ; Size ( j ) ; s \}\end{matrix} \{ \begin{matrix}Const\_F \_Wt ( [ δ ( {i}_{1} ) … δ ( i ) - 1 ] , \\ [ δ ( {j}_{1} ) … δ ( j ) - 1 ] , s - {s}_{2} ) + \\ Const\_F \_Wt ( [ δ ( i ) … i - 1 ] , \\ [ δ ( j ) … j - 1 ] , {s}_{2} - 1 ) + \\ d ( {T}_{1} [ i ] , {T}_{2} [ j ] ) .\end{matrix}\end{matrix} \qquad Theorem III$$

Theorem III naturally leads to a recursive algorithm, except that its time and space complexities will be prohibitively large. The main drawback with using Theorem III is that when substitutions are involved, the quantity Const_F_Wt(T₁[δ(i₁) . . . i], T₂[δ(j₁) . . . j], s) between the forests T₁[δ(i₁) . . . i] and T₂[δ(j₁) . . . j] is computed using the Const_F_Wts of the forests T₁[δ(i₁) . . . δ(i)-1] and T₂[δ(j₁) . . . δ(j)-1] and the Const_F_Wts of the remaining forests T₁[δ(i) . . . i-1] and T₂[δ(j) . . . j-1]. If we note that, under certain conditions, the removal of a sub-forest leaves us with an entire tree, the computation is simplified. Thus, if δ(i)=δ(i₁) and δ(j)=δ(j₁) (i.e., i and i₁, and j and j₁ span the same subtree), the subforests from T₁[δ(i₁) . . . δ(i)-1] and T₂[δ(j₁) . . . δ(j)-1] do not get included in the computation. If this is not the case, the Const_F_Wt(T₁[δ(i₁) . . . i], T₂[δ(j₁) . . . j], s) can be considered as a combination of the Const_F_Wt(T₁[δ(i₁) . . . δ(i)-1], T₂[δ(j₁) . . . δ(j)-1], s-s₂)) and the tree weight between the trees rooted at i and j respectively, which is Const_T_Wt(i, j, s₂). This is stated below.

$$Let {i}_{1} ∈ Anc ( i ) and {j}_{1} ∈ Anc ( j ) . Then the following is true \text{:} \\ If δ ( i ) = δ ( {i}_{1} ) and δ ( j ) = δ ( {j}_{1} ) then \\ Const\_F \_Wt ( {T}_{1} [ δ ( {i}_{1} ) … i ] , {T}_{2} [ δ ( {j}_{1} ) … j ] , s ) = Min \{ \begin{matrix}Const\_F \_Wt ( {T}_{1} [ δ ( {i}_{1} ) … i - 1 ] , {T}_{2} [ δ ( {j}_{1} ) … j ] , s ) + d ( {T}_{1} [ i ] , λ ) \\ Const\_F \_Wt ( {T}_{1} [ δ ( {i}_{1} ) … i ] , {T}_{2} [ δ ( {j}_{1} ) … j - 1 ] , s ) + d ( λ , {T}_{2} [ j ] ) \\ Const\_F \_Wt ( {T}_{1} [ δ ( {i}_{1} ) … δ ( i ) - 1 ] , {T}_{2} [ δ ( {j}_{1} ) … δ ( j ) - 1 ] , s - 1 ) + \\ d ( {T}_{1} [ i ] , {T}_{2} [ j ] )\end{matrix} \\ otherwise , \\ Const\_F \_Wt ( {T}_{1} [ δ ( {i}_{1} ) … i ] , {T}_{2} [ δ ( {j}_{1} ) … j ] , s ) = \begin{matrix}Min \{ \begin{matrix}Const\_F \_Wt ( {T}_{1} [ δ ( {i}_{1} ) … i - 1 ] , {T}_{2} [ δ ( {j}_{1} ) … j ] , s ) = d ( {T}_{1} [ i ] , λ ) \\ Const\_F \_Wt ( {T}_{1} [ δ ( {i}_{1} ) … i ) , {T}_{2} [ δ ( {j}_{1} ) … j - 1 ] , s ) + d ( λ , {T}_{2} [ j ] ) \\ \begin{matrix}Min \\ 1 \leq {s}_{2} \leq Min \{ Size ( i ) ; Size ( j ) ; s \}\end{matrix} \{ \begin{matrix}Const\_F \_Wt ( {T}_{1} [ δ ( {i}_{1} ) … δ ( i ) - 1 ] , \\ {T}_{2} [ δ ( {j}_{1} ) … δ ( j ) - 1 ] , s - {s}_{2} ) + \\ Const\_F \_Wt ( i , j , {s}_{2} ) .\end{matrix}\end{matrix}\end{matrix} \qquad Theorem IV$$

Theorem IV suggests that we can use a dynamic programming flavored algorithm to solve the constrained tree editing problem. The theorem also asserts that the distances associated with the nodes which are on the path from i₁ to δ(i₁) get computed as a by-product in the process of computing the Const_F_Wt between the trees rooted at i₁ and j₁. These distances are obtained as a by-product because, if the forests are trees, Const_F_Wt is retained as a Const_T_Wt. The set of nodes for which the computation of Const_T_Wt must be done independently before the Const_T_Wt associated with their ancestors can be computed is called the set of Essential_Nodes, and these are merely those nodes for which the computation would involve the second case of Theorem IV as opposed to the first.

We define the set Essential_Nodes of tree T as:

Essential_Nodes(T)={k| there exists no k′>k such that δ(k)=δ(k′)}.

By way of explanation, if k is in Essential_Nodes(T) then either k is the root or k has a left sibling.

Intuitively, this set will be the roots of all subtrees of tree T that need separate computations. Thus, the Const_T_Wt can be computed for the entire tree if Const_T_Wt of the Essential_Nodes are computed, and using these stored values the rest of the Const_T_Wts can be computed. Using Theorem IV we can now develop a bottom-up approach for computing the Const_T_Wt between all pairs of subtrees. Note that the function δ( ) and the set Essential_Nodes ( ) can be computed in linear time.

We shall now compute Const_T_Wt(i, j, s) and store it in a permanent three-dimensional array Const_T_Wt. In the interest of brevity the algorithms used in this paper are omitted here, but can be found in [OZL98]. The correctness of Algorithm T_Weights is proven in detail in [OL94].

As a result of invoking Algorithm T_Weights (which repeatedly invokes Algorithm Compute_Const_T_Wt for all pertinent values of i and j) we will have computed the constrained inter-tree edit distance between T₁ and T₂ subject to the constraint that the number of substitutions performed is s, for all feasible substitutions. The space required by the above algorithm is obviously O(|T₁|*|T₂|*Min{|T₁|, |T₂|}). If Span (T) is the Min{Depth(T), Leaves(T)}, the algorithm's time complexity is O(|T₁|*|T₂|*(Min{|T₁|, |T₂|})²*Span(T₁)* Span(T₂)).

Applications of the Method

This invention provides such a novel means by which tree structures, in the respective application domains, can be compared. The invention can be used for identifying an original tree, which is a member of a dictionary of labeled ordered trees. However, when the pattern to be recognized is occluded and only noisy information of a fragment of the pattern is available, the problem encountered can be perceived as one of recognizing a tree by processing the information in one of its noisy subtrees or subsequence trees. The invention performs this classification and recognition by processing a Noisy Subsequence-Tree (NSuT), which is a noisy or garbled version of any one arbitrary Subsequence-Tree (SuT) of the original tree. Thus, in its basic form, the invention can be applied to any field which compares tree structures, and in particular to the areas of statistical, syntactic and structural pattern recognition. In general, the invention will have potential applications in all the areas of computer science where either the modeling or the knowledge representation involves trees.

Although the invention as described herein uses the postorder representation of trees when traversed from left to right, the invention can be implemented also in a straightforward manner for the traversal which follows a right to left postorder traversal.

### EXAMPLES

### Example I

Tree Representation

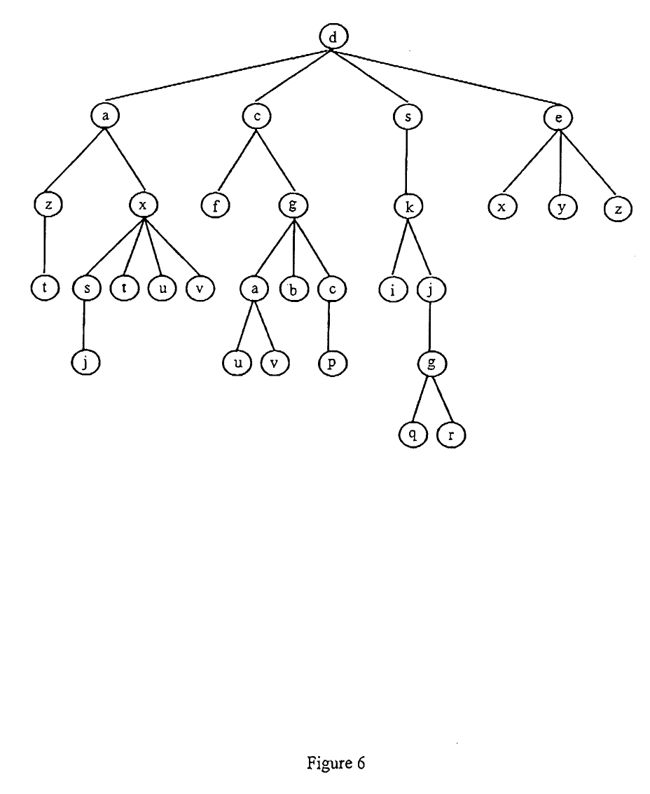

In this implementation of the algorithm we have opted to represent the tree structures of the patterns studied as parenthesized lists in a post-order fashion. Thus, a tree with root ‘a’ and children B, C and D is represented as a parenthesized list L=(B C D ‘a’) where B, C and D can themselves be trees in which cases the embedded lists of B, C and D are inserted in L. A specific example of a tree (taken from our dictionary) and its parenthesized list representation is given in FIG. 6.

In our first experimental set-up the dictionary, H, consisted of 25 manually constructed trees which varied in sizes from 25 to 35 nodes. An example of a tree in H is given in FIG. 6. To generate a NSuT for the testing process, a tree X* (unknown to the classification algorithm) was chosen. Nodes from X* were first randomly deleted producing a subsequence tree, U. In our experimental set-up the probability of deleting a node was set to be 60%. Thus although the average size of each tree in the dictionary was 29.88, the average size of the resulting subsequence trees was only 11.95.

The Garbling Process

The garbling effect of the noise was then simulated as follows. A given subsequence tree U, was subjected to additional substitution, insertion and deletion errors, where the various errors deformed the trees as described above. This was effectively achieved by passing the string representation through a channel causing substitution, insertion and deletion errors analogous to the one used to generate the noisy subsequences in [Oo87] and which has recently been formalized in [OK98]. However, as opposed to merely mutating the string representations as in [OK98] the reader should observe that we are manipulating the underlying list representation of the tree. This involves ensuring the maintenance of the parent/sibling consistency properties of a tree—which are far from trivial.

In our specific scenario, the alphabet involved was the English alphabet, and the conditional probability of inserting any character a ∈ A given that an insertion occurred was assigned the value 1/26. Similarly, the probability of a character being deleted was set to be 1/20. The table of probabilities for substitution (the confusion matrix) was based on the proximity of the character keys on a standard QWERTY keyboard [Oo86, Oo87, OK96].

Experimental Results

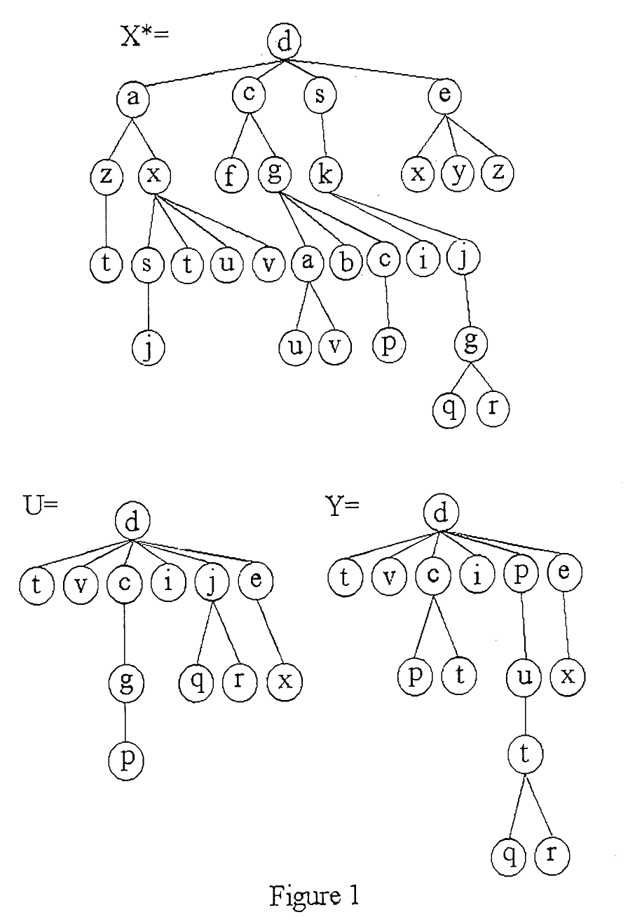

In our experiments ten NSuTs were generated for each tree in H yielding a test set of 250 NSuTs. The average number of tree deforming operations done per tree was 3.84. A typical example of the NsuTs generated, its associated subsequence tree and the tree in the dictionary which it originated from is given in FIG. 1. Table I gives the average number of errors involved in the mutation of a subsequence tree, U. Indeed, after considering the noise effect of deleting nodes from X* to yield U, the overall average number of errors associated with each noisy subsequence tree is 21.76.

TABLE I
The noise statistics associated with the set of noisy
subsequence trees used in testing.

| Type of | Number of | Average |
|---|---|---|
| errors | errors | error per tree |
| Insertion | 493 | 1.972 |
| Deletion | 313 | 1.252 |
| Substitution | 153 | 0.612 |

| | |
|---|---|
| Total average error | 3.836 |

The results that were obtained were remarkable. 232 out of 250 NSuTs were correctly recognized, which implies an accuracy of 92.80%. We believe that this is quite overwhelming considering the fact that we are dealing with 2-dimensional objects with an unusually high (about 73%) error rate at the node and structural level.

### Example II

Tree Representation

In the second experimental set-up, the dictionary, H, consisted of 100 trees which were generated randomly. Unlike in the above set (in which the tree-structure and the node values were manually assigned), in this case the tree structure for an element in H was obtained by randomly generating a parenthesized expression using the following stochastic context-free grammar G, where,

G=<N, A, G, P>, where,

N={T, S, $} is the set of non-terminals,

A is the set of terminals—the English alphabet, G is the stochastic grammar with associated probabilities, P, given below:

T→(S$) with probability 1,

S→(SS) with probability p₁,

S→(S$) with probability 1-p₁,

S→($) with probability p₂,

$→a with probability 1, where a ∈ A is a letter of the underlying alphabet.

Note that whereas a smaller value of P₁ yields a more tree-like representation, a larger value of p₁ yields a more string-like representation. In our experiments the values of p₁ and p₂ were set to be 0.3 and 0.6 respectively. The sizes of the trees varied from 27 to 35 nodes.

Once the tree structure was generated, the actual substitution of ‘$’ with the terminal symbols was achieved by using the benchmark textual data set used in recognizing noisy subsequences [Oo87]. Each ‘$’ symbol in the parenthesized list was replaced by the next character in the string. Thus, for example, the parenthesized expression for the tree for the above string was:

((((((((((($)$)$)(($)$)$)$)$)$)((((($)($)(($)$)$)$)$)$)$)$)$)

The ‘$’'s in the string are now replaced by terminal symbols to yield the following list:

(((((((((((i)n)t)h)((i)s)s)e)c)t)((((((i)o)((n)w)e)c)a)((((l)c)((u)l)(((a)t)e)t)h)e)a)p)o)s)

The actual underlying tree for this string can be deduced from Example I.

The Garbling Process

The process as described in Example I was used to generate the NSuTs. The average size of the resulting subsequence trees was only 13.42 instead of 31.45 for the original trees in the dictionary. In our experiments five NSuTs were generated for each tree in H yielding a test set of 500 NSuTs. The average number of tree deforming operations done per tree was 3.77. Table V gives the average number of errors involved in the mutation of a subsequence tree, U. Indeed, after considering the noise effect of deleting nodes from X* to yield U, the overall average number of errors associated with each noisy subsequence tree is 21.8. The list representation of a subset of the hundred patterns used in the dictionary and their NSuTs is given in Table II.

TABLE II
The noise statistics associated with the set of
noisy subsequcnce trees used in testing.

| Type of | Number of | Average |
|---|---|---|
| errors | Errors | error per tree |
| Insertion | 978 | 1.956 |
| Deletion | 601 | 1.202 |
| Substitution | 306 | 0.612 |

| | |
|---|---|
| Total average error | 3.770 |

Experimental Results

Out of the 500 noisy subsequence trees tested, 432 were correctly recognized, which implies an accuracy of 86.4%. The power of the scheme is obvious considering the fact we are dealing with 2-dimensional objects with an unusually high (about 69.32%) error rate. Also, the corresponding uni-dimensional problem (which only garbled the strings and not the structure) gave an accuracy of 95.4% [Oo87].

### REFERENCES

[DH73] R. O. Duda and P. E. Hart, Pattern Classification and Scene Analysis, John Wiley and Sons, New York, (1973).

[KM91] P. Kilpelainen and H. Mannila, “Ordered and unordered tree inclusion”, Report A-1991-4, Dept. of Comp. Science, University of Helsinki, Aug. 1991; to appear in SIAM Journal on Computing.

[LON89] S.-Y. Le, J. Owens, R. Nussinov, J.-H. Chen B. Shapiro and J.V. Maizel, “RNA secondary structures: comparison and determination of frequently recurring substructures by consensus”, Comp. Appl. Biosci. 5, 205-210 (1989),

[LNM89] S.-Y Le, R. Nussinov, and J.V. Maizel, “Tree graphs of RNA secondary structures and comparisons”, Computers and Biomedical Research, 22, 461-473 (1989).

[Lu79] S. Y. Lu, “A tree-to-tree distance and its application to cluster analysis”, IEEE Trans Pattern Anal. and Mach. Intell., Vol. PAMI 1, No. 2: pp. 219-224 (1979).

[Lu84] S. Y. Lu, “A tree-matching algorithm based on node splitting and merging”, IEEE -Trans. Pattern Anal. and Mach. Intell., Vol. PAMI 6, No. 2: pp. 249-256 (1984).

[Oo86] B. J. Oommen, “Constrained string editing”, Inform. Sci., Vol. 40: pp. 267-284 (1986).

[Oo87] B. J. Oommen, “Recognition of noisy subsequences using constrained edit distances”, IEEE Trans. Pattern Anal. and Mach. Intell., Vol. PAMI 9, No. 5: pp. 676-685 (1987).

[OK98] B. J. Oommen and R. L. Kashyap, “A formal theory for optimal and information theoretic syntactic pattern recognition”, Pattern Recognition, Vol. 31, 1998, pp. 1159-1177.

[OL94] B. J. Oommen, and W. Lee, “Constrained Tree Editing”, Information Sciences, Vol. 77 No. 3, 4: pp. 253-273 (1994).

[OZL96] B. J. Oommen, K. Zhang, and W. Lee IEEE Transactions on Computers, Vol.TC-45, Dec. 1996, pp.1426-1434.

[SK83] D. Sankoff and J. B. Kruskal, Time wraps, string edits, and macromolecules: Theory and practice of sequence comparison, Addison-Wesley, (1983).

[Se77] S. M. Selkow, Inform. Process. Letters, Vol. 6, No. 6: pp. 184-186 (1977).

[Sh88] B. Shapiro, “An algorithm for comparing multiple RNA secondary structures”, Comput. Appl. Biosci., 387-393 (1988).

[SZ90] B. Shapiro and K. Zhang, Comput. Appl. Biosci. vol. 6, no. 4, 309-318 (1990).

[Ta79] K. C. Tai, J. Assoc. Comput. Mach., Vol. 26: pp. 422-433 (1979).

[TSSS87] Y. Takahashi, Y. Satoh, H. Suzuki and S. Sasaki, “Recognition of largest common structural fragment among a variety of chemical structures”, Analytical Science Vol. 3, 23-28 (1987).

[WF74] R. A. Wagner and M. J. Fischer, J. Assoc. Comput. Mach., Vol. 21: pp. 168-173 (1974).

[Zh90] K. Zhang, “Constrained string and tree editing distance”, Proceeding of the IASTED International Symposium, New York, pp. 92-95 (1990).

[ZJ94] K. Zhang and T. Jiang, Information Processing Letters, 49, 249-254 (1994).

[ZS89] K. Zhang and D. Shasha, SIAM J. Comput. Vol. 18, No. 6: pp. 1245-1262 (1989).

[ZSS92] K. Zhang, R. Statman, and D. Shasha, Information Processing Letters, 42, 133-139 (1992).

[ZSW92] K. Zhang, D. Shasha and J. T. L. Wang, Proceedings of the 1992 Symposium on Combinatorial Pattern Matching, CPM92, 148-1619 (1992).

I claim:

1. A method executed in a computer system for comparing the similarity of a target tree to each of the trees in a set of trees, said target tree and each of the trees in the set of trees having tree nodes and having tree values associated with such tree nodes, said tree values being from an alphabet of symbols, comprising the steps of:
a. calculating at least one inter-symbol edit distance between the symbols of the said alphabet
b. for each tree in the set of trees,
i. calculating at least one value related to the number of substitution operations required to transform that tree into the target tree;
ii. calculating a constraint related to said at least one value;
iii. calculating an inter-tree constrained edit distance between that tree and the target tree related to the said constraint;
c. selecting at least one tree from the set of trees, said at least one tree having an inter-tree constrained edit distance to the target tree which is less than the largest calculated inter-tree constrained edit distance for the set of trees.

2. A method as in claim 1, wherein in step (bii), the constraint is also related to the size of the smaller of the target tree and that tree.

3. A method as in claim 1, wherein the target tree and each of the trees in the set of trees are represented in a left-to-right postorder traversal.

4. A method as in claim 2, wherein the target tree and each of the trees in the set of trees are represented in a left-to-right postorder traversal.

5. A method as in claim 1, wherein the target tree and each of the trees in the set of trees are represented in a right-to-left postorder traversal.

6. A method as in claim 2, wherein the target tree and each of the trees in the set of trees are represented in a right-to-left postorder traversal.

7. A method executed in a computer system for comparing the similarity of a target tree to each of the trees in a set of trees, said target tree and each of the trees in the set of trees having tree nodes and having tree values associated with such tree nodes, said tree values being from an alphabet of symbols, comprising the steps of:
a. calculating at least one inter-symbol edit distance between the symbols of the said alphabet;
b. for each tree in the set of trees,
i. calculating at least one value related to the number of deletion operations required to transform that tree into the target tree;
ii. calculating a constraint related to said at least one value;
iii. calculating an inter-tree constrained edit distance between that tree and the target tree related to the said constraint;
c. selecting at least one tree from the set of trees, said at least one tree having an inter-tree constrained edit distance to the target tree which is less than the largest calculated inter-tree constrained edit distance for the set of trees.

8. A method as in claim 7, wherein in step (bii), the constraint is also related to the size of the smaller of the target tree and that tree.

9. A method as in claim 7, wherein the target tree and each of the trees in the set of trees are represented in a left-to-right postorder traversal.

10. A method as in claim 8, wherein the target tree and each of the trees in the set of trees are represented in a left-to-right postorder traversal.

11. A method as in claim 7, wherein the target tree and each of the trees in the set of trees are represented in a right-to-left postorder traversal.

12. A method as in claim 8, wherein the target tree and each of the trees in the set of trees are represented in a right-to-left postorder traversal.

13. A method executed in a computer system for comparing the similarity of a target tree to each of the trees in a set of trees, said target tree and each of the trees in the set of trees having tree nodes and having tree values associated with such tree nodes, said tree values being from an alphabet of symbols, comprising the steps of:
a. calculating at least one inter-symbol edit distance between the symbols of the said alphabet;
b. for each tree in the set of trees,
i. calculating at least one value related to the number of insertion operations required to transform that tree into the target tree;
ii. calculating a constraint related to said at least one value;
iii. calculating an inter-tree constrained edit distance between that tree and the target tree related to the said constraint;
c. selecting at least one tree from the set of trees, said at least one tree having an inter-tree constrained edit distance to the target tree which is less than the largest calculated inter-tree constrained edit distance for the set of trees.

14. A method as in claim 13, wherein in step (bii), the constraint is also related to the size of the smaller of the target tree and that tree.

15. A method as in claim 13, wherein the target tree and each of the trees in the set of trees are represented in a left-to-right postorder traversal.

16. A method as in claim 14, wherein the target tree and each of the trees in the set of trees are represented in a left-to-right postorder traversal.

17. A method as in claim 13, wherein the target tree and each of the trees in the set of trees are represented in a right-to-left postorder traversal.

18. A method as in claim 14, wherein the target tree and each of the trees in the set of trees are represented in a right-to-left postorder traversal.

19. A method executed in a computer system for comparing the similarity between a target tree and at least one other tree comprising the steps of:
a. calculating an inter-tree constrained edit distance between the target tree and the at least one other tree;
b. selecting the at least one other tree if the inter-tree constrained edit distance between the target tree and the at least one other tree is less than a predetermined amount.
